(19) United States
(12) Patent Application Publication
(10) Pub. No.: US 2026/0288540 A1
(43) Pub. Date: Sep. 24, 2026

(54) EXPOSING CONTROL TO ENABLE INTERACTIVE SCHEDULERS FOR CLOUD CLUSTER ORCHESTRATION SYSTEMS

(71) Applicant: Microsoft Technology Licensing, LLC, Redmond, WA (US)

(72) Inventors: Willis LANG, Edina, MN (US); Justin Grant MOELLER, Eden Prairie, MN (US); Ajay KALHAN, Redmond, WA (US); Monika COLIC, Belgrade (RS); Aleksandar CUKANOVIC, Belgrade (RS); Nikola PUZOVIC, Belgrade (RS); Marko STOJANOVIC, Belgrade (RS); Jiaqi LIU, Bellevue, WA (US); Arnd Christian KÖNIG, Kirkland, WA (US); Yi SHAN, Bellevue, WA (US); Vivek Ravindranath NARASAYYA, Redmond, WA (US)

(73) Assignee: Microsoft Technology Licensing, LLC, Redmond, WA (US)

(21) Appl. No.: 19/685,244

(22) Filed: May 22, 2026

Related U.S. Application Data
(63) Continuation of application No. 17/674,173, filed on Feb. 17, 2022.

(51) Int. Cl. G06F 9/50

(52) U.S. Cl. CPC G06F 9/5083; G06F 9/5016; G06F 9/5044; G06F 9/5055; G06F 9/5077

(57) ABSTRACT

Methods, systems, and computer program products are provided for a compute cluster comprising placement and load balancing (PLB) logic that receives data (e.g., state metadata) relating to a service (e.g., database service) executing on the compute cluster, from a resource manager executing on the compute cluster, via a first API associated with the resource manager. The PLB logic receives second data from the service via a second API and determines whether a PLB action is indicated based on one of the second data or a combination of the first data and the second data. When a PLB action is indicated, the PLB logic sends a command to the resource manager to execute the PLB action. The PLB logic also receives queries from clients external to the compute cluster and may spawn a child PLB logic to offload PLB operations, respond to queries, or perform software validation in the child.

### CROSS-REFERENCE TO RELATED APPLICATIONS

This application is a continuation of U.S. patent application Ser. No. 17/674,173 filed Feb. 17, 2022, entitled “Exposing Control to Enable Interactive Schedulers for Cloud Cluster Orchestration Systems,” which is incorporated herein by reference in its entirety. To the extent appropriate is a claim of priority is made to the above disclosed application.

### BACKGROUND

Managed cloud systems operate cloud scale services that run in clusters in globally distributed datacenters. The services may include various types of services, applications, processes, pods, containers, etc. An orchestrations system (i.e., cluster orchestrator) may be utilized to manage the services in a cluster. For example, cloud database systems (e.g., Microsoft® Azure® SQL Database) may employ an orchestration system (e.g., Microsoft® Azure® Service Fabric, Google's Kubernetes®, etc.) to manage database (DB) services deployed in a cluster. In this regard, the orchestration system may perform service placement, failover, defragmentation, and other types of operations on the deployed services.

### SUMMARY

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for a compute cluster comprising one or more nodes. Each of the one or more nodes comprises a physical machine or a virtual machine. Placement and load balancing (PLB) logic executes on the compute cluster. The PLB logic is configured to receive first data relating to a service executing on the compute cluster from a resource manager executing on the compute cluster via a first application programming interface (API) associated with the resource manager. The PLB logic is configured to (1) receive second data relating to the service from the service via a second API that is different from the first API, (2) determine whether a PLB action is indicated based on one of the second data or a combination of the first data and the second data, and (3) in response to determining that the PLB action is indicated, send a command to the resource manager to execute the PLB action.

Further features and advantages of embodiments, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 is diagram of a cluster orchestration system with PLB logic configured to interact with services deployed in a cluster and/or external clusters and services, according to an example embodiment.

FIG. 2 is a flowchart of a method for PLB logic to control a PLB action based on interaction with at least one of a resource manager or a deployed service, according to an example embodiment.

FIG. 3 is a flowchart of a method for storing data in a durable storage coupled to the PLB logic, according to an example embodiment.

FIG. 4 is a flowchart of a method for PLB logic of a cluster to interact with a PLB client, according to an example embodiment.

FIG. 5 is a flowchart of a method for PLB logic of a cluster to determine a PLB action command for execution by a resource manager based on a request received from a PLB client, according to an example embodiment.

FIG. 6 is a flowchart of a method for PLB logic of a cluster to receive and/or respond to a what-if query with a PLB client, according to an example embodiment.

FIG. 7 is a flowchart of a method for PLB logic of a cluster to receive and reply to queries from a PLB client, according to an example embodiment.

FIG. 8 is block diagram of a cluster orchestration system with PLB logic configured to interact with external clusters and services and spawn child PLB logic to offload PLB logic processing, according to an example embodiment.

FIG. 9 is a flowchart of a method for PLB logic of a cluster to spawn a PLB logic child and offload processing from the PLB logic to the child PLB.

FIG. 10 is a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the disclosed embodiments. The scope of the embodiments is not limited only to the aspects disclosed herein. The disclosed embodiments merely exemplify the intended scope, and modified versions of the disclosed embodiments are also encompassed. Embodiments are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

If the performance of an operation is described herein as being “based on” one or more factors, it is to be understood that the performance of the operation may be based solely on such factor(s) or may be based on such factor(s) along with one or more additional factors. Thus, as used herein, the term “based on” should be understood to be equivalent to the term “based at least on.”

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments.

As described above, managed cloud systems operate cloud scale services that run in clusters in globally distributed datacenters. An orchestration system (i.e., cluster orchestrator) may be utilized to manage the services. For example, cloud database systems (e.g., Microsoft® Azure® SQL Database) may employ a cluster orchestrator (e.g., Microsoft® Azure® Service Fabric, Google's Kubernetes®, etc.) to manage database (DB) services deployed in a cluster. In general, a cluster orchestrator deploys services or applications into a cluster, monitors their health, availability, and responsiveness, and if those things deteriorate, the cluster orchestrator attempts to remedy the problem by moving, restarting, rebalancing, removing or adding resources. The services or applications feed information to the cluster orchestrator such as what are the parameter descriptions of a node (e.g., capacity across metric dimensions, subsets or groupings of nodes, health), and what are the parameter descriptions of a service or application (e.g., what metric subspace does it occupy, health, replica equality in terms of health priority, resource priority, etc.). The orchestration system may perform placement, failover, defragmentation, and other types of operations on the deployed services. More specifically, a resource manager may interact with services deployed in its cluster to collect metadata from the services in order to determine the state of the cluster.

The resource manager may communicate the state metadata to placement and load balance (PLB) logic (i.e., a scheduler), which may search for solutions based on the state metadata and determine a remediation action. For example, the remediation action may indicate where to place services in the cluster, when and/or where to move the services among nodes in the cluster, or whether to change the role of a service (e.g., from a primary replica to a secondary replica). The resource manager may place and load balance the services across a set of nodes in the cluster, based on the remediation action forwarded by the PLB logic. The state of a cluster may be based on metrics (e.g., central processing unit (CPU) utilization, memory utilization, disk utilization, etc.) reported by the services to the resource manager, and policies (e.g., settings) configured for the PLB logic. The PLB logic may also be referred to as a scheduler.

Although the managed elements in a node are referred to herein as services, the managed elements may comprise one or more services, microservices, applications, processes, pods, containers, etc., or a combination thereof. For example, the managed elements may comprise one or more of structured query language (SQL) database services, web pages, web gateways, data science tools, etc. The services may be referred to as replicas, services, microservices, containers, databases, pods, etc. In this regard, secondary replicas may provide redundancy for primary replicas for fault tolerance.

The PLB logic may be configured to receive state information for services in a cluster and search for scheduling or placement solutions that improve (e.g., optimize) the performance of the cluster according to objectives or policies that are input by users (e.g., cluster administrators). Executing a search algorithm may inform the PLB logic of what should be done with respect to scheduling and placing services and applications in the cluster. For example, in some orchestration systems, the resource manager may inform the PLB logic that a node has become unresponsive, and the PLB logic may search for a solution and indicate a remediation action for the resource manager to perform, thereby maintaining availability and performance for all of the service replicas that reside on that node.

In some orchestration systems, users (e.g., cluster administrators) can configure their own PLB logic against APIs that define the PLB service. In this manner, users may customize and upgrade the PLB logic itself with regard to making PLB decisions. Moreover, with respect to inputs to the orchestration system, primitive data types that are used for inputs to a resource manager from services or applications deployed in a cluster, allow for definition of a metric (e.g., dynamic utilization of a resource (e.g., disk usage, CPU usage, memory usage, etc.) by a service at a particular time). In this regard, the resource manager may receive a single value of the appropriate data type for the defined metric. However, a user may wish to write a new PLB algorithm or policy that consumes a complex data type for the resource utilization, (e.g. a tuple (i, j, k) where i is an instant reading (integer), j is running maximum over timespan ts (integer), and k is a variance over timespan ts (float)). With current cluster orchestrator architectures this would not be done because the orchestration system is not able to understand and transmit arbitrary input constructs throughout the entire distributed orchestration system to the resource manager. Instead, only simply defined primitives are available. If a user wants to enable use of this complex metric data type, the user would need to redesign the entire orchestration system to do so, potentially for every single customization of the resource manager. In other words, one would need to re-plumb the orchestration system itself, which may not be possible if it impacts other users or the generality of the orchestration system.

In one example use case, a user (e.g., system administrator) may wish to modify a PLB logic application to enable “differential overbooking” of structured query language (SQL) serverless databases (e.g., elastic, fault tolerant DB service availability in a cloud system) and SQL provisioned databases (e.g., assigned a specified amount of computer resources in the cloud system). For example, it may be desired that a serverless system will be substantially more overbooked (e.g., greater than 2×) than a provisioned system (e.g., 1.5×). To implement this differential overbooking, a number of different new types of metric inputs are used, which correspond to an SQL serverless resource usage model. For example, the metric inputs may comprise a minimum bound guarantee, a maximum bound guarantee, and a current usage. The new inputs help to inform desirable serverless and provisioned co-location densities (e.g., weighting allows skewed placement tendencies). There are also additional inputs to help inform the PLB logic about the value or sensitivity of a database to failovers (i.e., moving of databases around a cluster). These inputs protect provisioned systems from quality of service (QOS) loss. To enable this, node agents in the cluster orchestrator that the SQL DBs communicate with would need to be modified to understand these new (and arbitrary) input constructs. For example, the cluster orchestrator transport protocol, which is fully baked and custom, and the main system services in the orchestrator runtime (e.g., failover manager, hosting, etc.) also need to understand these service description augmentations before finally sending them to the PLB logic. All of these changes are (1) specific to an SQL usage scenario, (2) would require substantial engineering of the “base” cluster orchestrator system services (infra) that may impact non-SQL DB customers/users, and (3) would benefit from a “what-if” testing capability.

Methods and systems described herein provide PLB logic that comprises an independent interactive entity that a user (e.g., cluster owner) can define and customize, such that services (e.g., DB services) deployed in a cluster can directly transmit customized inputs (e.g., metrics) to the PLB logic and influence its decision making. As this PLB framework allows the PLB logic to know about input data types and information that are unknown to the rest of the orchestration system, the PLB logic may be configured as a stateful, fault tolerant service. In other words, if the PLB logic itself crashes, or its node goes down, the state information that the PLB logic has stored for use in execution (and the rest of the cluster orchestrator may not have), may be persisted and replicated. Therefore, the PLB logic uses a robust enough database (e.g., durable storage) that provides replicated fault tolerance.

As described above, a resource manager may interact with services deployed within its cluster. In the present disclosure, instead of the PLB logic receiving requests and state metadata only via the resource manager (e.g., receiving it based on remote procedure calls (RPC) from the resource manager), the PLB logic may interact directly with the services deployed within its cluster as well as with external entities such as services and/or clusters that are deployed outside of its cluster. For example, application programming interfaces (APIs) may be exposed between the PLB logic and PLB clients within these internal or external components. In this manner, the PLB logic may obtain data (e.g., state metadata) that the resource manager does not have access to and/or does not have the capability to process. Furthermore, the PLB logic may be configured to search for solutions (e.g., placement and load balancing solutions) based on this directly received data, and send PLB actions that are determined base on this data, to the resource manager for the resource manager to execute. Moreover, external clusters and/or services may be provided access to query the PLB logic directly (e.g., via APIs or RPCs) about its current state, and also to ask for solutions to certain scenarios (i.e., states) that may yet happen (e.g., in “what-if” queries).

In some aspects, the interactive PLB logic (i.e., scheduler) described herein may be data-decoupled from the rest of the orchestration system including the resource manager. In this manner, there can be new types of properties, new constructs of data (e.g., metrics) and new policies that a user can define for the PLB logic to handle, without making modifications to the rest of the orchestration system (e.g. the resource manager), which know nothing about them. In other words, the resource manager and other elements of the orchestration system that communicate directly with the resource manager would not need to be upgraded to handle these new types of properties, constructs of data, and policies that the PLB logic can handle directly. In some implementations, these other elements of the orchestration system (e.g., the resource manager, the node agents, and the API by which they communicate) are intended to be used in conjunction with a wide variety of different types of deployed services (i.e., they are intended to be general purpose). Requiring these components to be modified to communicate and manage custom metrics associated with a particular type of service such as a DB service may be an extremely expensive way to achieve the goal of providing the custom metrics to the PLB logic (e.g., requiring development effort and making the components more complex, which increases system processor cycles, I/O, and storage usage). The present disclosure recognizes this cost of modifying the resource manager and avoids this cost by having the custom metrics communicated directly from the specific services for which they are relevant (e.g., DB services, etc.) to the PLB logic. In other words, the disclosed methods and systems avoid having to modify the resource manager, the node agents, and the API by which they communicate, which is a cost that would have been borne by each and every entity that uses the orchestration system, even those entities that don't deploy DB services or those entities that do deploy DB services but have no use of the custom metrics.

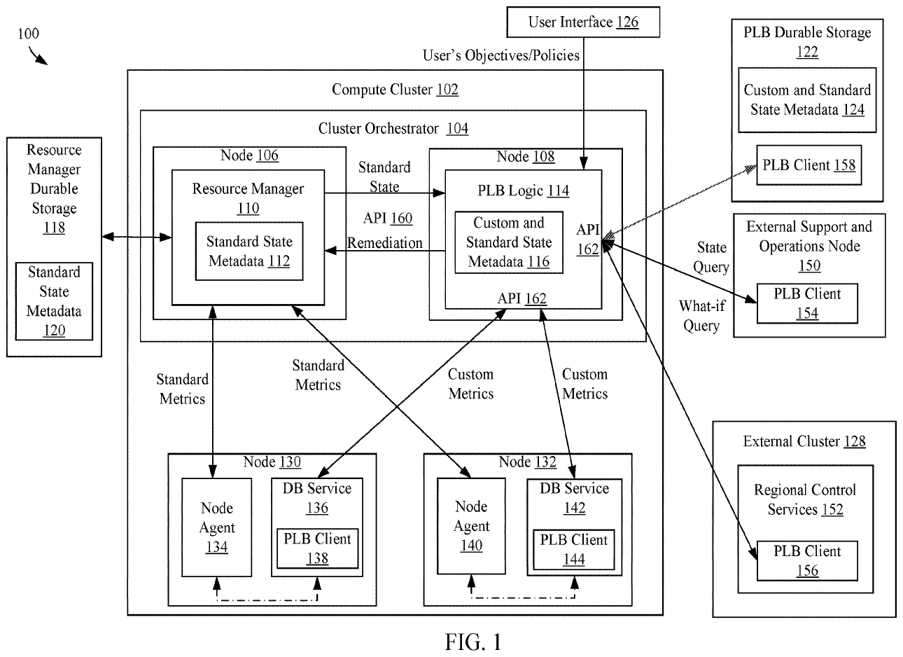

Interactive PLB logic may be implemented in various ways. For instance, FIG. 1 is diagram of a cluster orchestration system with PLB logic configured to interact with services deployed in its cluster and/or with external clusters and services, according to an example embodiment. As shown in FIG. 1, system 100 includes a compute cluster 102, a cluster orchestrator 104, a resource manager durable storage 118, a PLB durable storage 122, a user interface 126, an external support and operations node 150, and an external cluster 128. Compute cluster 102 comprises a cluster orchestrator 104, a node 130, and a node 132. Cluster orchestrator 104 comprises a node 106 and a node 108. Node 106 comprises a resource manager 110 and standard state metadata 112. Node 108 comprises a PLB logic 114 and custom and standard state metadata 116. Node 130 comprises a node agent 134, a database (DB) service 136, and a PLB client 138. Node 132 comprises a node agent 140, a DB service 142, and a PLB client 144. Resource manager durable storage 118 comprises standard state metadata 120. PLB durable storage 122 comprises custom and standard state metadata 124 and PLB client 158. External support and operations node 150 comprises a PLB client 154. External cluster 128 comprises regional control services 152 which itself comprises a PLB client 156. Also shown in system 100 are API 160 and APIs 162.

Cluster orchestrator 104 may be referred to as an orchestration system. Compute cluster 102 may comprise a compute cluster and may be referred to as a ring. Node 130 and/or node 132 may be referred to as data nodes. Node 106 and node 108 may be referred to as control nodes. Although FIG. 1 shows separate nodes comprising control plane components (e.g., resource manager 110 and PLB logic 114) and data plane components (e.g., DB service 136 and DB service 142), the disclosure is not limited in the regard, and a node may host a combination of control plane components and data plan components. For example, PLB logic 114 may run on the same node as a user service (e.g., a DB service, web service, etc.). Also, a node may host a plurality of the same type of services or a plurality of different types of services. Moreover, resource manager 110 and PLB logic 114 may run on the same node.

Resource manager durable storage 118 and PLB durable storage 122 may comprise any suitable physical storage mechanism, including, for example, magnetic disc (e.g., in a hard disk drive), optical disc (e.g., in an optical disk drive), solid-state drive (SSD), a ROM (read only memory) device, and/or any other suitable type of physical, hardware-based persistent storage medium.

External support and operations node 150 may be utilized by users (e.g., service engineers) to determine the status of a cluster (e.g., state metadata) and/or to work on problems in a cluster (e.g., by influencing PLB logic 114 on incident mitigation or testing of PLB functions). PLB logic 114 may be accessible to the user via PLB client 154 and an API of APIs 162 for sending queries and/or commands to PLB logic 114.

External cluster 128 may comprise a control plane cluster and may comprise one or more control services such as regional control services 152 having PLB client 156. Regional control services 152 may be configured to administrate operations in an entire region of a cloud system (e.g., a data center). Regional control services 152 may be configured to interact with PLB 114 via PLB client 156 and one or more APIs of APIs 162.

Cluster orchestrator 104 may be configured to perform various operations to dynamically deploy and manage services in compute cluster 102. For example, resource manager 110 may be configured to instantiate or place services such as DB service 136 and/or DB service 142 inside nodes 130 and 132 respectively based on indications or commands from PLB logic 114. API 160 may comprise a set of function calls that PLB logic 114 and resource manager 110 may be configured to utilize with regard to the commands and other communications.

User interface 126 may be coupled to PLB logic 114 and may be utilized to configure PLB logic 114 by a user. For example, a user may set various objectives and/or policies that PLB logic 114 utilizes to determine an action or a response to a query based on state metadata indicating the state of compute cluster 102. The state of compute cluster 102 may be determined based at least in part on metrics (e.g., central processing unit (CPU) utilization, memory utilization, disk usage, etc.) reported by DB service 136 and/or DB service 142 to resource manager 110, and policies (e.g., settings) for compute cluster 102 configured for PLB logic 114. PLB logic 114 may also be referred to as a scheduler or scheduler 114. The state of compute cluster 102 may also be determined based at least in part on state metadata reported by DB service 136 and/or DB service 142 directly to PLB logic 108 (i.e., bypassing resource manager 110).

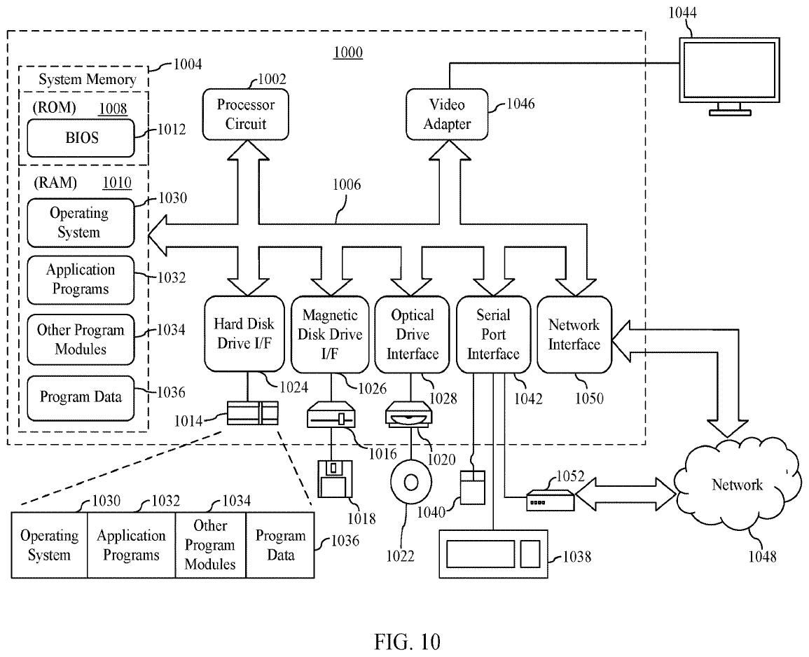

Compute cluster 102 may comprise a plurality of nodes. Each node may comprise a physical machine having, for example, one or more central processing units (CPUs), microprocessors, multi-processors, processing cores, or any other hardware-based processor types described herein or otherwise known. In addition, or alternatively, a node may comprise a virtual machine. Node 106 may comprise or be assigned to any suitable type of memory device (described with respect to FIG. 10) that resource manager 110 may have access to for storing standard state metadata 112. Node 108 may also comprise or be assigned to any suitable type of memory device (described with respect to FIG. 10) that PLB logic 114 may have access to for storing custom and standard state metadata 116. Each of nodes 106 and 108 may be configured to perform control plane functions for cluster orchestrator 104.

Each of nodes 130 and 132 may comprise one or more services, applications, processes, pods, containers, etc., which may be referred to herein as “services” for ease of description. For example, although each of node 130 and node 132 is shown as having one implemented database service, each node may comprise a plurality of services, which may include one or more service types such as, without limitation, a database, a website, a web gateway, a data science tool, a real time stream processing engine, a web-based document management system, or a storage system. Furthermore, the methods and systems described herein with respect to DB service 136 and/or DB service 142, may be applied to the other types of services (e.g., other than database services).

Node agents may be utilized, in part, to communicate information between the nodes and services implemented in compute cluster 102 and resource manager 110. For example, node agent 134 may be configured to transmit information including metrics that are related to services implemented in node 130 to resource manager 110. For example, node agent 134 may transmit metrics concerning CPU usage, memory usage, disk usage, etc., for DB service 136 to resource manager 110. The information transmitted to resource manager 110 from node agent 134 may be referred to as standard metrics or standard state metadata. Similarly, node agent 140 may transmit standard state metadata related to node 132 services, such as DB service 142, to resource manager 110. Resource manager 110 may be configured to keep a copy of the information received from the nodes as standard state metadata 112, and may also store the standard state metadata in resource manager durable storage 118 as standard state metadata 120. Resource manager 110 may also be configured to invoke API 160 to send data of standard state metadata 112 to PLB logic 114 and receive an indication of an action to be taken based on standard state metadata 112 via API 160. PLB logic 114 may be configured to keep a copy of the standard state metadata in custom and standard state metadata 116 and/or store the standard state metadata from resource manager 110 to PLB durable storage 122 as custom and standard state metadata 124. PLB logic 114 may further be configured to determine any actions to perform in compute cluster 102 (e.g., placement and load balancing of services) and may provide instructions or commands to resource manager 110 via API 160 for performing the determined actions. For example, resource manager 110 may be configured to automatically manage workloads executed in compute cluster 102 by placing additional DB services in node 130 and/or node 132 (and/or in other nodes that may be added in compute cluster 102). Resource manager 110 may be configured to perform load balancing across nodes 130 and 132 (and/or additional nodes in compute cluster 102), scaling node capacity up or down, performing failover to one or more databases when an instantiated database becomes unavailable, defragmenting data (e.g., reorganizing indexes according to the physical order of data), and/or performing other types of operations in cluster 102.

PLB logic 114 may also be communicatively coupled to services deployed internal to compute cluster 102 (e.g., DB service 136 and DB service 142) and/or to services, nodes and/or clusters deployed external to compute cluster 102. For example, PLB logic 114 may be configured to communicate via one or more APIs 162 (different than API 160), with internal and external services, nodes, and clusters. These one or more APIs 162 may be accessed through PLB clients within the internal and external services, nodes and clusters. For ease of description, each of the one or more APIs (other than API 160) that are used for communicating between PLB logic 114 and the internal and external services, nodes, and clusters may be referred to as an API of APIs 162, or they may be referred to collectively as APIs 162. For example, PLB logic 114 may expose one or more APIs of APIs 162 for communicating with DB service 136 via PLB client 138, and with DB service 142 via PLB client 144. Moreover, PLB logic 114 may expose one or more APIs of APIs 162 for communicating with external support and operations node 150 via PLB client 154, with regional control services 152 via PLB client 156, and/or with PLB durable storage 122 via PLB client 158. In this manner, data types communicated directly between PLB logic 114 and resource manager 110 via API 160 may be different or decoupled from many of the data types communicated directly between PLB logic 114 and one or more of the internal and external services, nodes, and clusters (e.g., DB service 136, DB service 142, external support and operations node 150, regional control services 152, and PLB durable storage 122) via one or more APIs 162. With this data-decoupling in place, a user can define new properties, data constructs (e.g., complex metrics), and different policies that are supported by PLB logic 114 and one or more of the APIs of APIs 162 without having to modify resource manager 110, API 160, resource manager durable storage 118, node agents 134 and 140, or other cluster orchestrator 104 elements. In other words, PLB logic 114 may be configured to handle new types of data while resource manager 110 and API 160 are not configured to handle it and would not need to be upgraded to do so. For example, API 160 and various APIs exposing resource manager 110 to resource manager durable storage 118, node agent 134, and node agent 140 would not need to be modified to handle the new or different types of data that PLB logic 114 can handle.

Moreover, PLB logic 114 and one or more of the APIs of APIs 162 may be configured to handle custom metrics or custom data for any one or more of the internal or external services, nodes, and clusters. For example, a new API 162 of APIs 162 may be implemented between PLB logic 114 and PLB client 154 for communicating new (or custom) data types that are used by external support and operations node 150. Resource manager 110 and other internal and external services, nodes and clusters may not utilize these new types of data that are customized for PLB client 154, such that other APIs of APIs 162 and API 160 would not need to be modified to handle these new types of data. Similarly, PLB client 138 and/or PLB client 144 may utilize a particular API of APIs 162 for communication of certain custom data types (e.g., custom metrics) to PLB logic 114, where other APIs of APIs 162, resource manager 110, and API 160 are not configured to handle these custom data types.

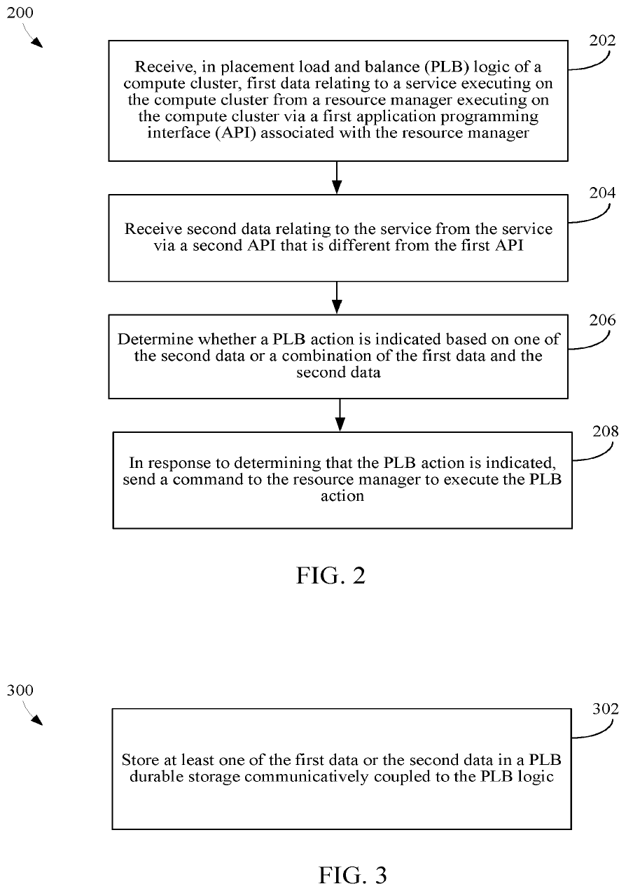

As described above, PLB logic 114 may be configured to receive state metadata for DB service 136 and/or DB service 142 from resource manager 110 via API 160. PLB logic 114 may also be configured to receive state metadata and/or queries directly from DB service 136 and/or DB service 142, external support and operations node 150, and/or regional control services 152, via one or more APIs of APIs 162. PLB logic 114 may be configured to search for solutions based on the received state metadata or queries, and based on policies configured in PLB logic 114. As a result, PLB logic 114 may be configured to determine a remediation action and/or a response to a query. PLB logic 114 may be configured to indicate PLB actions, such as where to place additional services (e.g., DB services or other types of services) in compute cluster 102 or in an external cluster, which services to remove, when and/or where to move services among nodes in compute cluster 102, or whether to change the role of a service (e.g., from a primary replica to a secondary replica). The remediation action may be indicated in a communication from PLB logic 114 to resource manager 110 via API 160 where resource manager 110 may be configured to implement the remediation action. Moreover PLB logic 114 may be configured to communicate a query response or remediation action directly to the internal or external clusters, nodes, or services via one or more APIs of APIs 162. For instance, FIG. 2 is a flowchart 200 of a method for PLB logic to control a PLB action based on interaction with at least one of a resource manager or a deployed service, according to an example embodiment. Flowchart 200 may be implemented in system 100. For purposes of illustration, flowchart 200 is described with reference to FIG. 1. Other structural and operational embodiments will be apparent to persons skilled in the relevant art(s) based on the following discussion regarding flowchart 200.

Flowchart 200 begins with step 202. In step 202, placement load and balance (PLB) logic of a compute cluster may receive first data relating to a service executing on the compute cluster from a resource manager executing on the compute cluster via a first application programming interface (API) associated with the resource manager. For example, API 160 may be associated with resource manager 110, and PLB logic 114 of compute cluster 102 may be configured to receive data (e.g., standard state metadata 112) from resource manager 110 via API 160. The data may comprise metrics (e.g., standard state metadata) communicated by node agent 134 for DB service 136 and/or metrics communicated by node agent 140 for DB service 142.

In step 204, second data relating to the service may be received from the service via a second API that is different from the first API. For example, an API of APIs 162 may be associated with PLB client 138 and/or PLB client 144, and may not be associated with resource manager 110. PLB logic 114 may be configured to receive data (e.g., state metadata or custom state metadata) from PLB client 138 for DB service 136 and/or from PLB client 140 for DB service 142 via API 162.

In step 206, it is determined whether a PLB action is indicated based on one of the second data or a combination of the first data and the second data. For example, PLB logic 114 may be configured to determine whether a PLB action (e.g., manage workloads executed in compute cluster 102, place additional DB services, remove DB services, load balance across nodes, scale node capacity up or down, perform a DB failover, defragment data (e.g., reorganizing indexes according to the physical order of data), etc.) is indicated. PLB logic 114 may determine whether the PLB action is indicated based on the second data received via API 162 or a combination of the second data received via API 162 and the first data received via API 160. PLB logic 114 may analyze the first data and/or the second data, and search for a PLB action based on the second data or a combination of the second data and the first data. The PLB action may be determined based on objectives or policies configured for PLB 114.

In step 208, in response to determining that the PLB action is indicated, a command may be sent to the resource manager to execute the PLB action. For example, PLB logic 114 may be configured to communicate the indicated PLB action to resource manager 110, for execution of the PLB action by resource manager 110.

PLB logic 144 may keep track of state data for its own cluster and/or other clusters and may store the state data in PLB durable storage 122 to enhance fault tolerance. The state data may comprise data received from resource manager 110 via API 160, or data received from sources internal or external to compute cluster 102 via an API of APIs 162. For example, the data may be standard state metadata and/or custom state metadata. For instance, FIG. 3 is a flowchart 300 of a method for storing data in a durable storage coupled to the PLB logic, according to an example embodiment. Flowchart 300 may be implemented in system 100. For purposes of illustration, flowchart 300 is described with reference to FIG. 1. Other structural and operational embodiments will be apparent to persons skilled in the relevant art(s) based on the following discussion regarding flowchart 300.

Flowchart 300 comprises step 302. In step 302, at least one of the first data or the second data is stored in a PLB durable storage communicatively coupled to the PLB logic. For example, PLB logic 114 may be configured to store first data received from resource manager 110 via API 160 to PLB durable storage 122 (e.g., via an API of APIs 162 and PLB client 158). Further, PLB logic 114 may be configured to store second data received from DB service 136 and/or DB service 142 via an API of APIs 162 and PLB client 138 and/or PLB client 144 respectively, to PLB durable storage 122 (e.g., via an API of APIs 162 and PLB client 158).

In some embodiments, PLB logic 114 may be configured to interact with one or more cloud system components outside or inside of compute cluster 102. For instance, FIG. 4 is a flowchart 400 of a method for PLB logic of a cluster to interact with a PLB client, according to an example embodiment. Flowchart 400 may be implemented in system 100. For purposes of illustration, flowchart 400 is described with reference to FIG. 1. Other structural and operational embodiments will be apparent to persons skilled in the relevant art(s) based on the following discussion regarding flowchart 400.

Flowchart 400 comprises step 402. In step 402, queries about current state information may be received from a PLB client and the queries may be replied to. For example, PLB logic 114 may expose one or more APIs of APIs 162 to PLB clients in entities that are internal or external to compute cluster 102 (e.g., PLB client 138 in DB service 138, PLB client 144 in DB service 142, PLB client 158 in PLB durable storage 122, PLB client 154 in external support and operations node 150, and/or PLB client 156 in external cluster 128). In one example embodiment, external support and operations node 150 may invoke an API of APIs 162 to send a query to PLB logic 114 regarding the current state of one or more services (e.g., DB service 136 or DB service 142) or other components in compute cluster 102. PLB logic 114 may be configured to receive the queries about current state from external support and operations node 150 and return information from custom and standard state metadata 116 (or from custom and standard state metadata 124 stored in PLB durable storage 122). For example, the current state may be analyzed in external support and operations node 150 to determine how effectively PLB logic 114 is functioning.

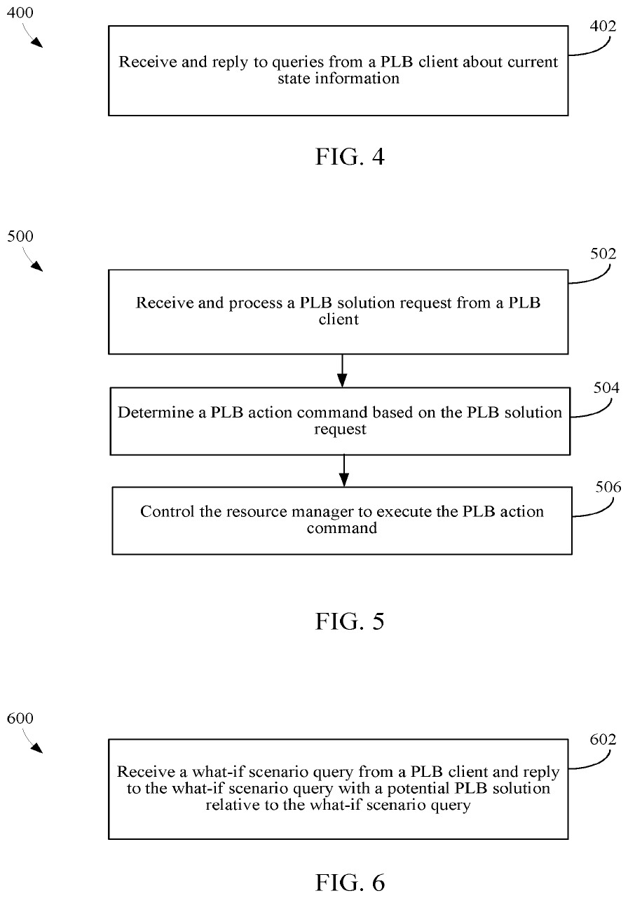

FIG. 5 is a flowchart 500 of a method for PLB logic of a cluster to determine a PLB action command for execution by a resource manager based on a request received from a PLB client, according to an example embodiment. Flowchart 500 may be implemented in system 100. For purposes of illustration, flowchart 500 is described with reference to FIG. 1. Other structural and operational embodiments will be apparent to persons skilled in the relevant art(s) based on the following discussion regarding flowchart 500.

Flowchart 500 begins with step 502. In step 502, a PLB solution request from a PLB client is received and processed. For example, a PLB client internal or external to cluster 102 may send the PLB solution request. In one example, external support and operations node 150 may be configured to transmit information to PLB logic 114 via PLB client 154 and an API of APIs 162. A user (e.g., a service engineer) may wish to influence PLB logic 114 with respect to PLB activities in compute cluster 102 (e.g., for incident mitigation or testing of PLB functions). The service engineer may invoke an API of APIs 162 to send a request to PLB logic 114 for implementing a solution or a PLB action in compute cluster 102 (e.g. with respect to DB service 138 and/or DB service 142). PLB logic 114 may be configured to receive and analyze the PLB solution request. In some embodiments, prior to sending the PLB solution request to PLB logic 114, the service engineer may invoke an API of APIs 162 to send a query to PLB logic 114 requesting the current state of one or more services (e.g., DB service 136 or DB service 142). The current state may be utilized to determine the PLB solution.

In step 504, a PLB action command may be determined based on the PLB solution request. For example, PLB logic 114 may be configured to utilize information in the PLB solution request to determine the PLB action.

In step 506, the resource manager may be controlled to execute the PLB action command. For example, PLB logic 114 may be configured to send a control command for performing the PLB action to resource manager 110 via API 160. In response, resource manager may be configured to perform the action command. For example, resource manager may add a new DB service (not shown) to node 130.

In some embodiments, PLB logic 114 may be configured to handle what-if queries from entities internal or external to compute cluster 102. For instance, FIG. 6 is a flowchart 600 of a method for PLB logic of a cluster to receive and/or respond to a what-if query with a PLB client, according to an example embodiment. Flowchart 600 may be implemented in system 100. For purposes of illustration, flowchart 600 is described with reference to FIG. 1. Other structural and operational embodiments will be apparent to persons skilled in the relevant art(s) based on the following discussion regarding flowchart 600.

Flowchart 600 comprises step 602. In step 602, a what-if scenario query is received from a PLB client internal or external to the compute cluster and the what-if scenario query is replied to with a potential PLB solution relative to the what-if scenario query. For example, a user of external support and operations node 150 may invoke an API of APIs 162 via PLB client 154 and request a PLB solution based on metadata posed in the what-if scenario query. PLB logic 114 may be configured to determine one or more PLB solutions based on the posed metadata received from external support and operations node 150, and transmit the one or more PLB solutions to external support and operations node 150 via an API of APIs 162 and PLB client 154. In this regard, the posed metadata may be utilized to gain knowledge of PLB logic 114 functionality under various potential states in compute cluster 102, or to validate PLB logic software.

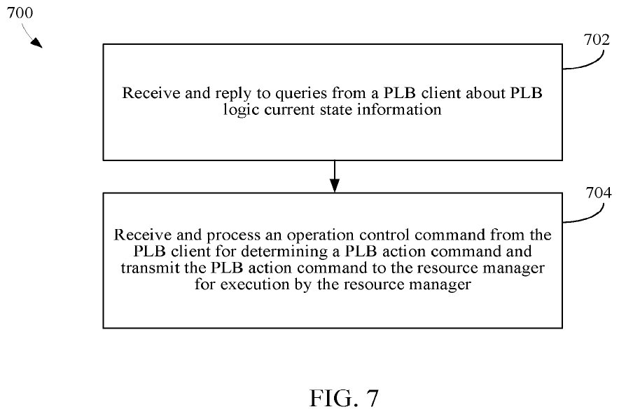

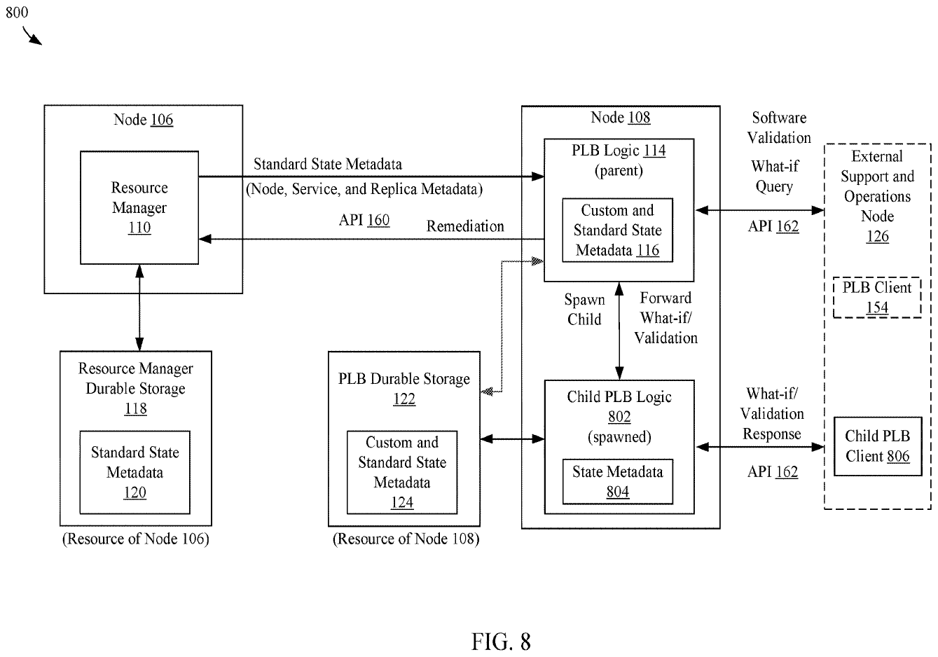

FIG. 7 is a flowchart 700 of a method for PLB logic of a cluster to receive and reply to queries from a PLB client, according to an example embodiment. Flowchart 700 may be implemented in system 100. For purposes of illustration, flowchart 700 is described with reference to FIG. 1. Other structural and operational embodiments will be apparent to persons skilled in the relevant art(s) based on the following discussion regarding flowchart 700.

Flowchart 700 begins with step 702. In step 702, queries about PLB logic current state information may be received from a PLB client and may be replied to. For example, the queries may be received from PLB clients internal or external to cluster 102. In one example, external cluster 128 may be a control plane cluster and may comprise regional control services 152. Regional control services 152 may be configured to control operations in clusters throughout a region (e.g., in a datacenter), and may retrieve state data from clusters in the region for various types of decision making. Regional control services 152 may be communicatively coupled to PLB logic 114 via PLB client 156 and one or more APIs of APIs 162. PLB logic 114 may be configured to receive a query from regional control services 152 via an API of APIs 162. The query may request state metadata for compute cluster 102 (e.g., metric information from DB service 136 and/or DB service 140). PLB logic 114 may be configured to respond to the query with state metadata from custom and standard state metadata 116 (or durable storage 122) and transmit the state metadata to regional control services 152 via the API of APIs 162 and PLB client 126.

In step 704, an operation control command is received from the PLB client and processed for determining PLB action commands for the resource manager to execute. For example, PLB logic 114 may be configured to receive a control command from regional control services 152 via PLB client 156 and an API of APIs 162. The command may indicate a course of PLB action for resource manager 110 to perform. PLB logic 110 may be configured to determine and transmit a command indicating the course of PLB action to resource manager 110 via API 160. In some embodiments, regional control services 152 may utilize state metadata received from PLB logic 114 to determine the PLB course of action.

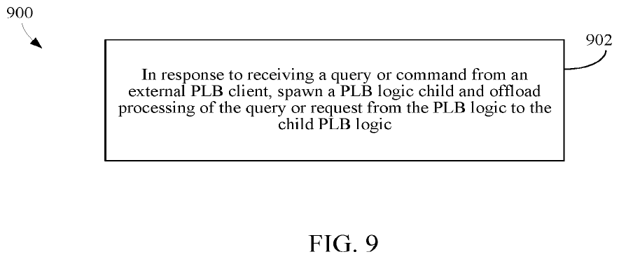

Tasking PLB logic 114 with workloads including both of handling compute cluster 102 PLB logic tasks and tasks from services and nodes external to compute cluster 102 may cause PLB logic 114 to become overloaded and thus, PLB logic 114 may function inefficiently and service performance may become impaired. To prevent PLB logic 114 from becoming overloaded, PLB logic 114 may be configured to offload some of its tasks. For instance, FIG. 8 is diagram of a cluster orchestration system 800 with PLB logic configured to interact with external clusters and services and spawn child PLB logic to offload PLB logic processing, according to an example embodiment.

As shown in FIG. 8, system 800 comprises node 106 and node 108 (of compute cluster 102 and cluster orchestrator 104), resource manager durable storage 118, standard state metadata 120, PLB durable storage 122, custom and standard state metadata 124, and external support and operations node 126 (external to compute cluster 102). Node 106 comprises resource manager 110. Node 108 comprises a PLB logic 114, custom and standard state metadata 116, child PLB logic 802, and state metadata 804. External support and operations node 126 comprises PLB client 154 and child PLB client 806. Also shown in FIG. 8 are API 160, and APIs 162.

Although not all of the elements of system 100 are shown in system 800, system 800 may include all of the elements of system 100.

FIG. 9 is a flowchart 900 of a method for PLB logic of a cluster to spawn a PLB logic child and offload processing from the PLB logic to the child PLB logic, according to an example embodiment. Flowchart 900 may be implemented in systems 100 and 800. For purposes of illustration, flowchart 900 is described with reference to FIGS. 1 and 8. Other structural and operational embodiments will be apparent to persons skilled in the relevant art(s) based on the following discussion regarding flowchart 900.

Flowchart 900 comprises step 902. In step 902, in response to receiving a query or command from an external PLB client, a PLB logic child is spawned and processing of the query or command is offloaded to the child PLB logic. For example, PLB logic 114 may receive a query or a command directly from a service internal or external to compute cluster 102 (e.g., from external support and operations node 126, regional control service 152, DB service 136, etc.), and may offload the processing of the query or the command by spawning a child PLB logic 802 to process the query or command. Child PLB logic 802 may have the same PLB logic code and/or the same settings (e.g., objectives or policies for making PLB decisions) as PLB logic 114 (the parent), or one or both of these may be different in child PLB logic 802 relative to the parent PLB logic 114. In one example, PLB logic 114 may receive a query or command from external support and operations node 126 via PLB client 154 and an API of APIs 162. PLB logic 114 may be configured to spawn (or generate) child PLB logic 802, and pass the query to child PLB logic 802. Child PLB logic 802 may be configured to store all or a portion of custom and standard state metadata 116 as state metadata 804 for use in processing the query or command. Moreover, in some embodiments, child PLB logic 802 may have direct access to PLB durable storage 122 and custom and standard metadata 124 for use in processing the query or command. PLB child logic 802 may process the query or command and may invoke and API of APIs 162 to transmit the results of the processing as a response to the query or command to external support and operations node 126 via child PLB client 806. In this manner, the load associated with processing the query or command may be carried by child PLB logic 802 and isolated from PLB logic 114, such that PLB logic 114 may focus on handling compute cluster 102 PLB tasks.

Moreover, PLB logic 114 may be configured to spawn a child PLB to offload any task received from any suitable source, including the tasks described with respect to FIGS. 2-7. In one example, a child PLB logic may be spawned to perform software validation tests. Based on a command from external support and operations node 150, a PLB logic child may be spawned with new code for processing certain PLB functions that relate to the validation tests, while parent PLB logic 110 may function as usual with different code. Queries and commands may be sent to the child PLB logic to test the behavior of the new code, which may be observed in the responses received from the child PLB logic by external support and operations node 150 using an API of APIs 162.

### III. Example Computer System Implementation

Embodiments described herein may be implemented in hardware, or hardware combined with software and/or firmware. For example, embodiments described herein may be implemented as computer program code/instructions configured to be executed in one or more processors and stored in a computer readable storage medium. Alternatively, embodiments described herein may be implemented as hardware logic/electrical circuitry.

As noted herein, the embodiments described, including but not limited to, system 100 of FIG. 1 and system 800 of FIG. 8, along with any components and/or subcomponents thereof, as well any operations and portions of flowcharts/flow diagrams described herein and/or further examples described herein, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), an application specific integrated circuit (ASIC), a trusted platform module (TPM), and/or the like. A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments described herein may be implemented in one or more computing devices similar to a mobile system and/or a computing device in stationary or mobile computer embodiments, including one or more features of mobile systems and/or computing devices described herein, as well as alternative features. The descriptions of computing devices provided herein are provided for purposes of illustration, and are not intended to be limiting. Embodiments may be implemented in further types of computer systems, as would be known to persons skilled in the relevant art(s).

FIG. 10 is a block diagram of an example processor-based computer system 1000 that may be used to implement various embodiments. The computing devices of systems 100 and 800, including computing devices hosting compute cluster 102, cluster orchestrator 104, node 106, node 108, node 130, node 132, user interface 126, external support and operations node 150, external cluster 128, may each include any suitable type of computing device, mobile or stationary, such as a desktop computer, a server, a video game console, etc. For example, any of the computing devices of systems 100 and 800, including computing devices hosting compute cluster 102, cluster orchestrator 104, node 106, node 108, node 130, node 132, user interface 126 external support and operations node 150, external cluster 104 may be any type of mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™ operating system, etc.), a wearable computing device (e.g., a head-mounted device including smart glasses such as Google® Glass™, Oculus Rift® by Oculus VR, LLC, etc.), a stationary computing device such as a desktop computer or PC (personal computer), a gaming console/system (e.g., Microsoft Xbox®), Sony PlayStation®, Nintendo Wii® or Switch®, etc.), etc.

The computing devices of systems 100 and 800, including computing devices hosting compute cluster 102, cluster orchestrator 104, node 106, node 108, node 130, node 132, user interface 126, external support and operations node 150, and external cluster 128 may each be implemented in one or more computing devices containing features similar to those of computing device 1000 in stationary or mobile computer embodiments and/or alternative features. The description of computing device 1000 provided herein is provided for purposes of illustration, and is not intended to be limiting. Embodiments may be implemented in further types of computer systems, as would be known to persons skilled in the relevant art(s).

As shown in FIG. 10, computing device 1000 includes one or more processors, referred to as processor circuit 1002, a system memory 1004, and a bus 1006 that couples various system components including system memory 1004 to processor circuit 1002. Processor circuit 1002 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1002 may execute program code stored in a computer readable medium, such as program code of operating system 1030, application programs 1032, other programs 1034, etc. Bus 1006 represents one or more of any of several types of bus structures, including a memory bus or memory controller, a peripheral bus, an accelerated graphics port, and a processor or local bus using any of a variety of bus architectures. System memory 1004 includes read only memory (ROM) 1008 and random-access memory (RAM) 1010. A basic input/output system 1012 (BIOS) is stored in ROM 1008.

Computing device 1000 also has one or more of the following drives: a hard disk drive 1014 for reading from and writing to a hard disk, a magnetic disk drive 1016 for reading from or writing to a removable magnetic disk 1018, and an optical disk drive 1020 for reading from or writing to a removable optical disk 1022 such as a CD ROM, DVD ROM, or other optical media. Hard disk drive 1014, magnetic disk drive 1016, and optical disk drive 1020 are connected to bus 1006 by a hard disk drive interface 1024, a magnetic disk drive interface 1026, and an optical drive interface 1028, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMS, ROMs, and other hardware storage media.

A number of program modules may be stored on the hard disk, magnetic disk, optical disk, ROM, or RAM. These programs include operating system 1030, one or more application programs 1032, other programs 1034, and program data 1036. Application programs 1032 or other programs 1034 may include, for example, computer program logic (e.g., computer program code or instructions) for implementing compute cluster 102, cluster orchestrator 104, user interface 126, external support and operations node 150, external cluster 128, node 130, node 132, node 106, node 108, resource manager 110, PLB logic 114, node agent 134, database service 136, PLB client 138, node agent 140, database service 142, PLB client 144, regional control services 152, PLB client 154, PLB client 156, API 160, APIs 162, child PLB logic 802, child PLB client 806, flowchart 200, flowchart 300, flowchart 400, flowchart 500, flowchart 600, flowchart 700, and flowchart 900, and/or further embodiments described herein. Program data 1036 may include standard state metadata 112, custom and standard state metadata 116, custom and standard state metadata 124, state metadata 804, and/or further embodiments described herein.

A user may enter commands and information into computing device 1000 through input devices such as keyboard 1038 and pointing device 1040. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1002 through a serial port interface 1042 that is coupled to bus 1006, but may be connected by other interfaces, such as a parallel port, game port, or a universal serial bus (USB).

A display screen 1044 is also connected to bus 1006 via an interface, such as a video adapter 1046. Display screen 1044 may be external to, or incorporated in computing device 1000. Display screen 1044 may display information, as well as being a user interface for receiving user commands and/or other information (e.g., by touch, finger gestures, virtual keyboard, etc.). In addition to display screen 1044, computing device 1000 may include other peripheral output devices (not shown) such as speakers and printers.

Computing device 1000 is connected to a network 1048 (e.g., the Internet) through an adaptor or network interface 1050, a modem 1052, or other means for establishing communications over the network. Modem 1052, which may be internal or external, may be connected to bus 1006 via serial port interface 1042, as shown in FIG. 10, or may be connected to bus 1006 using another interface type, including a parallel interface.

As used herein, the terms “computer program medium,” “computer-readable medium,” and “computer-readable storage medium” are used to refer to physical hardware media such as the hard disk associated with hard disk drive 1014, removable magnetic disk 1018, removable optical disk 1022, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1032 and other programs 1034) may be stored on the hard disk, magnetic disk, optical disk, ROM, RAM, or other hardware storage medium. Such computer programs may also be received via network interface 1050, serial port interface 1042, or any other interface type. Such computer programs, when executed or loaded by an application, enable computing device 1000 to implement features of embodiments discussed herein. Accordingly, such computer programs represent controllers of computing device 1000.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Examples and Advantages

In an embodiment, a system with a compute cluster comprising one or more nodes, each of the one or more nodes comprises a physical machine or a virtual machine and a placement and load balancing (PLB) logic that executes on the compute cluster. The PLB logic is configured to receive first data relating to a service executing on the compute cluster from a resource manager executing on the compute cluster via a first application programming interface (API) associated with the resource manager. The PLB logic is configured to receive second data relating to the service from the service via a second API that is different from the first API and determine whether a PLB action is indicated based on one of the second data or a combination of the first data and the second data. In response to determining that the PLB action is indicated, the PLB logic is configured to send a command to the resource manager to execute the PLB action.

In an embodiment of the foregoing system, the system comprises a PLB durable storage communicatively coupled to the PLB logic. The PLB logic is further configured to store at least one of the first data or the second data in the PLB durable storage.

In an embodiment of the foregoing system, the PLB logic is communicatively coupled to a PLB client and the PLB logic is further configured to receive and reply to queries from the PLB client about current state information.

In an embodiment of the foregoing system, the PLB logic is communicatively coupled to a PLB client. The PLB logic is further configured to receive and process a PLB solution request from the PLB client, determine a PLB action command based on the PLB solution request, and control the resource manager to execute the PLB action command.

In an embodiment of the foregoing system, the PLB logic is communicatively coupled to a PLB client. The PLB logic is further configured to receive a what-if scenario query from the PLB client and reply to the what-if scenario query with a potential PLB solution relative to the what-if scenario query.

In an embodiment of the foregoing system, the PLB logic is communicatively coupled to a PLB client. The PLB logic is further configured to perform at least one of receiving and replying to queries from the PLB client about PLB logic current state information, or receiving and processing an operation control command from the PLB client for determining a PLB action command and transmitting the PLB action command to the resource manager for execution by the resource manager.

In an embodiment of the foregoing system, the PLB logic is further configured to in response to receiving a query or request from an external PLB client, spawn a PLB logic child and offload processing of the query or request from the PLB logic to the child PLB logic.

In an embodiment of the foregoing system, the service executing on the compute cluster comprises a database service.

In an embodiment, a method comprises receiving, in placement load and balance (PLB) logic of a compute cluster, first data relating to a service executing on the compute cluster from a resource manager executing on the compute cluster via a first application programming interface (API) associated with the resource manager. The method comprises receiving second data relating to the service from the service via a second API that is different from the first API and determining whether a PLB action is indicated based on one of the second data or a combination of the first data and the second data. In response to determining that the PLB action is indicated, the method further comprises sending a command to the resource manager to execute the PLB action.

In an embodiment of the foregoing method, at least one of the first data or the second data is stored in a PLB durable storage communicatively coupled to the PLB logic.

In an embodiment of the foregoing method, queries from a PLB client about current state information are received and replied to.

In an embodiment of the foregoing method, a PLB solution request from a PLB client is received and processed, a PLB action command is determined based on the PLB solution request, and the resource manager is controlled to execute the PLB action command.

In an embodiment of the foregoing method, a what-if scenario query is received from a PLB client and the what-if scenario query is replied to with a potential PLB solution relative to the what-if scenario query.

In an embodiment of the foregoing method, queries from a PLB client about PLB logic current state information are received and replied to, or an operation control command from the PLB client for determining a PLB action command is received and processed, and the PLB action command is transmitted to the resource manager for execution by the resource manager.

In an embodiment of the foregoing method, in response to receiving a query or request from a PLB client external to the compute cluster, a PLB logic child is spawned and processing of the query or request from the PLB logic is offloaded to the child PLB logic.

In an embodiment of the foregoing method, the service executing on the compute cluster comprises a database service.

In an embodiment, a computer-readable storage medium having program code recorded thereon that when executed by at least one processor causes the at least one processor to perform a method. The method comprises receiving, in placement load and balance (PLB) logic of a compute cluster, first data relating to a service executing on the compute cluster from a resource manager executing on the compute cluster via a first application programming interface (API) associated with the resource manager. Second data relating to the service is received from the service via a second API that is different from the first API. It is determined whether a PLB action is indicated based on one of the second data or a combination of the first data and the second data. In response to determining that the PLB action is indicated, a command is sent to the resource manager to execute the PLB action.

In an embodiment of the foregoing computer-readable storage medium, at least one of the first data or the second data is stored in a PLB durable storage communicatively coupled to the PLB logic.

In an embodiment of the foregoing computer-readable storage medium, queries from a PLB client about current state information are received and replied to.

In an embodiment of the foregoing computer-readable storage medium, a PLB solution request is received from a PLB client and processed, a PLB action command is determined based on the PLB solution request, and the resource manager is controlled to execute the PLB action command.

### V. Conclusion

While various embodiments of the present application have been described above, it should be understood that they have been presented by way of example only, and not limitation. It will be understood by those skilled in the relevant art(s) that various changes in form and details may be made therein without departing from the spirit and scope of the application as defined in the appended claims. Accordingly, the breadth and scope of the present application should not be limited by any of the above-described exemplary embodiments, but should be defined only in accordance with the following claims and their equivalents.

1.-20. (canceled)

21. A system, comprising:
a compute cluster comprising one or more nodes, each of the one or more nodes comprising at least one of a physical machine or a virtual machine; and
placement and load balancing (PLB) logic executing on the compute cluster, the PLB logic being configured to:
receive first data relating to a service executing on the compute cluster from a resource manager executing on the compute cluster via a first application programming interface (API) associated with the resource manager, the first data including state metadata collected by the resource manager from the compute cluster;
receive second data relating to the service from the service via a second API that is different from the first API and unassociated with the resource manager, the second data including custom metrics associated with the service;
determine whether a remediation action related to at least one of placement or load balancing is indicated based on the first data and the second data; and
in response to determining that the remediation action is indicated, executing the remediation action at least in part by sending a command to the resource manager to execute the remediation action.

22. The system of claim 21 further comprising a PLB durable storage communicatively coupled to the PLB logic, wherein the PLB logic is further configured to:
store at least one of the first data or the second data in the PLB durable storage.

23. The system of claim 21, wherein the PLB logic is communicatively coupled to a PLB client and the PLB logic is further configured to:
receive and reply to queries from the PLB client about current state information.

24. The system of claim 21, wherein the PLB logic is communicatively coupled to a PLB client and the PLB logic is further configured to:
receive and process a PLB solution request from the PLB client;
determine a PLB action command based on the PLB solution request; and
control the resource manager to execute the PLB action command.

25. The system of claim 21, wherein the PLB logic is communicatively coupled to a PLB client and the PLB logic is further configured to:
receive a what-if scenario query from the PLB client and reply to the what-if scenario query with a potential PLB solution relative to the what-if scenario query.

26. The system of claim 21, wherein the PLB logic is communicatively coupled to a PLB client and the PLB logic is further configured to perform at least one of:
receive and reply to queries from the PLB client about PLB logic current state information; or
receive and process an operation control command from the PLB client for determining a PLB action command and transmit the PLB action command to the resource manager for execution by the resource manager.

27. The system of claim 21, wherein the PLB logic is further configured to:
in response to receiving a query or request from an external PLB client, spawn a PLB logic child and offload processing of the query or request from the PLB logic to the child PLB logic.

28. The system of claim 21, wherein the service executing on the compute cluster comprises a database service.

29. A method in placement load and balance (PLB) logic of a compute cluster, comprising:
receiving first data relating to a service executing on the compute cluster from a resource manager executing on the compute cluster via a first application programming interface (API) associated with the resource manager, the first data including state metadata collected by the resource manager from the compute cluster;
receiving second data relating to the service from the service via a second API that is different from the first API and unassociated with the resource manager, the second data including custom metrics associated with the service;
determining whether a remediation action related to at least one of placement or load balancing is indicated based on the first data and the second data; and
in response to determining that the remediation action is indicated, executing the remediation action at least in part by sending a command to the resource manager to execute the remediation action.

30. The method of claim 29, further comprising:
storing at least one of the first data or the second data in a PLB durable storage communicatively coupled to the PLB logic.

31. The method of claim 29, further comprising:
receiving and replying to queries from a PLB client about current state information.

32. The method of claim 29, further comprising:
receiving and processing a PLB solution request from a PLB client;
determining a PLB action command based on the PLB solution request; and
controlling the resource manager to execute the PLB action command.

33. The method of claim 29, further comprising:
receiving a what-if scenario query from a PLB client and replying to the what-if scenario query with a potential PLB solution relative to the what-if scenario query.

34. The method of claim 29, further comprising at least one of:
receiving and replying to queries from a PLB client about PLB logic current state information; or
receiving and processing an operation control command from the PLB client for determining a PLB action command and transmitting the PLB action command to the resource manager for execution by the resource manager.

35. The method of claim 29, further comprising:
in response to receiving a query or request from a PLB client external to the compute cluster, spawning a PLB logic child and offloading processing of the query or request from the PLB logic to the child PLB logic.

36. The method of claim 29, wherein the service executing on the compute cluster comprises a database service.

37. A computer-readable storage medium having program code recorded thereon that when executed by at least one processor causes the at least one processor to perform a method in placement load and balance (PLB) logic of a compute cluster, the method comprising:
receiving first data relating to a service executing on the compute cluster from a resource manager executing on the compute cluster via a first application programming interface (API) associated with the resource manager, the first data including state metadata collected by the resource manager from the compute cluster;
receiving second data relating to the service from the service via a second API that is different from the first API and unassociated with the resource manager, the second data including custom metrics associated with the service;
determining whether a remediation action related to at least one of placement or load balancing is indicated based on the first data and the second data; and
in response to determining that the remediation action is indicated, executing the remediation action at least in part by sending a command to the resource manager to execute the remediation action.

38. The computer-readable storage medium of claim 37, wherein the method further comprises:
storing at least one of the first data or the second data in a PLB durable storage communicatively coupled to the PLB logic.

39. The computer-readable storage medium of claim 37, wherein the method further comprises:
receiving and replying to queries from a PLB client about current state information.

40. The computer-readable storage medium of claim 37, wherein the method further comprises:
receiving and processing a PLB solution request from a PLB client;
determining a PLB action command based on the PLB solution request; and
controlling the resource manager to execute the PLB action command.
